(19) United States
(12) Patent Application Publication
(10) Pub. No.: US 2005/0145090 A1
(43) Pub. Date: Jul. 7, 2005

(54) [BEAT BALLS]

(75) Inventor: Tino K Adognravi, Cleveland Heights, OH (US)

Correspondence Address: Tino K. Adognravi, 2509 Queenston Road, Cleveland Heights, OH, 44118, US

(73) Assignee: Tino K. Adognravi, Cleveland Heights, OH (US)

(21) Appl. No.: 10/707,636

(22) Filed: Dec. 29, 2003

(51) Int. Cl. G10D 13/08

(52) U.S. Cl. 84/410

(57) ABSTRACT

The beat balls are a set of two hollow spheres linked together with a string; the hollow spheres contain beads to generate a rattling sound similar to that of maracas when the spheres are shaken. The rattling bead sound is enhanced by the knocking sound generated by two hollow spheres when smacked together in a swinging motion while one of the spheres is held in the palm of the hand with the connecting string passing through the index finger and the middle finger. The swinging motion is repeated to create various speed and rhythmic patterns.

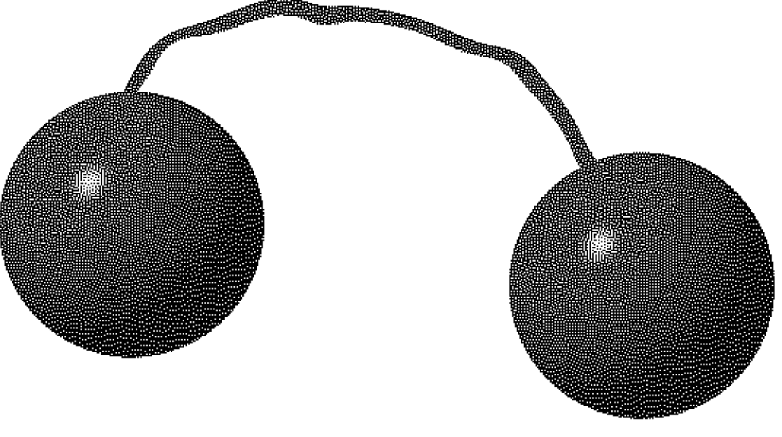

### BRIEF DESCRIPTION OF DRAWINGS

Entertaining rhythmic musical toy consist of two hollow spheres containing beads and joined by a string. The rhythmic sound is generated by the contact of the two spheres and the rattling sound of the beads inside the spheres. The contact between the two spheres is achieved by holding one sphere with the attaching string passing between the index finger and the middle finger and swinging the other sphere around the hand while moving the hand up and down and catching the swinging sphere after it hits the static sphere from the underside of the palm. This swinging motion is repeated to create different rhythms and rattling beads patterns.

### DETAILED DESCRIPTION

Beat Balls are an entertaining musical toy consisting of a set of two hollow spheres containing beads or any media that would create a rattling sound when the two beat balls are shaken. The two beat balls are linked together by a string. The beat balls can be made of hard plastic, wood or any material that would cause the two beat balls to make a “knocking sound” upon contact. The contact between the two beat balls is achieved by holding one beat ball with the attaching string passing between the index finger and the middle finger, and swinging the other beat ball around the hand while moving the hand up and down and catching the swinging beat ball after it hits the static beat ball from the underside of the palm. The swinging motion is repeated to create different rhythms and resonating beads patterns.

1. Beat Balls are an entertaining rhythmic musical toy which allows the player to generate a rhythmic appealing sound similar to that emitted by maracas but enhanced by the drum-like beat generated by the knocking sound between to two beat balls upon contact.
